(19) United States
(12) Patent Application Publication
(10) Pub. No.: US 2009/0047439 A1
(43) Pub. Date: Feb. 19, 2009

(54) METHOD AND APPARATUS FOR MANUFACTURING POROUS ARTICLES

(76) Inventors: James C. Withers, Tucson, AZ (US); Vladimir Shapovalov, Albuquerque, NM (US)

Correspondence Address: HAYES SOLOWAY P.C., 3450 E. SUNRISE DRIVE, SUITE 140, TUCSON, AZ, 85718, US

(21) Appl. No.: 12/189,658

(22) Filed: Aug. 11, 2008

Related U.S. Application Data
(60) Provisional application No. 60/956,374, filed on Aug. 16, 2007.

(51) Int. Cl. B05D 1/08

(52) U.S. Cl. 427/448; 118/620

(57) ABSTRACT

A method for producing porous materials which comprises directing a plasma stream containing particles of a base material in liquid or solid/liquid form onto a substrate under controlled conditions in which the particles spot weld to the substrate or to one another without full fusion, and establishing relative movement between the plasma stream and the substrate whereby the material is deposited as a porous structure of desired porosity and shape.

### CROSS REFERENCE TO RELATED APPLICATION

This application claims priority from U.S. Provisional Application Ser. No. 60/956,374, filed Aug. 16, 2007.

### BACKGROUND OF THE INVENTION

The invention generally relates to method and apparatus for manufacturing porous articles. The invention has particular utility for producing metallic materials having open or closed pore structures of predetermined sizes and shapes and will be described in connection with such utility although other utilities are contemplated.

### DESCRIPTION OF THE PRIOR ART

A number of techniques have been proposed for manufacturing porous metal articles. The most widely used techniques are those based on the sintering of powders, chips, fibers, nets, channeled plates and combinations thereof. Also known in the art are processes using a slurry which is foamed and subsequently baked and sintered. Other processes known in the art include slip forming or slurry casting techniques. In slip forming, porous cellular materials are produced by pouring slip into a porous mold whose contents are subsequently dried and baked to remove the slip fluid and leave behind a powder compact. Another method which is presently used is based on the depositing of a metal onto an organic substrate, such as polyurethane, which is then removed by thermal-decomposition.

In the field of metal casting of porous materials, there are a number of different techniques. Several methods of casting are similar to investment casting. In one method, a foamed plastic, having interconnecting pores, is filled with a fluidized refractory material which is subsequently hardened. Upon heating and vaporizating the plastic, a spongy, skeletal mold is produced. A melt is then poured into the mold and, after solidification, a cellular structure is obtained. This method has particular application with metals having low melting points.

A mold for producing a porous material with a high melting point can be made by compacting an inorganic powder material, which is soluble in at least one solvent, to form a porous solid having interconnected powder particles. The molten material is then introduced into the pores of the mold where it solidifies. After cooling, the inorganic material is removed by the solvent.

Another prior art technique employs a mold filled with granules. When a molten material is poured in the mold, the material penetrates into the voids between the granules and an interconnected cellular structure is produced once the granules are removed. The technique required for removing the granules will depend upon the specific granules utilized.

A mechanical method which produces a controlled pore structure involves a mold having opposing plates with pins protruding into the mold cavity. After a molten metal has been injected and solidified, the plates are moved apart and the pins removed providing the casting with its pore structure.

Foaming techniques also have been proposed. According to these methods, a foaming agent is added to a molten metal and the resulting foam is cooled to form a solid of foamed metal. Typical foaming agents include hydrides, silicon, aluminum, sulphur, selenium and tellurium.

A limitation of prior art foaming processes is that the size and distribution of the pores only can be controlled to a very limited extent. Another limitation of prior art foaming techniques which makes casting very difficult is the short time interval involved between adding the foaming agent and foam formation. Additional difficulties are caused by the premature decomposition of the foaming agent. If nonporous sections are desired within the casting, barrier layers must be provided producing additional difficulties. Thickening agents have been used in an attempt to control pore formation. However, these agents often produce negative effects with regard to the mechanical properties of the foamed metal.

Solutions to overcome the foregoing problems have been proposed which involve blowing bubbles of an inert gas into the molten material while the material concurrently solidifies. As such, the gas being blown into the melt causes the formation of hollow, semi-molten metal granules which bind together to form a cellular type structure.

All of the above methods for manufacturing porous materials have a common disadvantage of being complex. This complexity arises due to the necessity of involving a considerable number of operations and/or using a considerable number of preparatory stages. As a result, the cost of the produced product is high and the production rate is low, both of which make the resulting material commercially impractical.

The foregoing discussion of the prior art derives in large part from my earlier U.S. Pat. No. 5,181,549 which discloses a method for producing porous articles in which a base material (metal, alloy or ceramic) is melted within an autoclave in an atmosphere of a gas, containing hydrogen, under a specified pressure. The melt is exposed to the gas for a period of time such that the hydrogen is dissolved therein and its concentration within the melt has reached a prescribed saturation value.

After saturating, the melt (containing the dissolved hydrogen gas therein) is poured into a mold which also is located within the autoclave. After filling, the pressure within the autoclave is set to a prescribed level and the melt is cooled. The pressure at which the melt is cooled is referred to as the solidification pressure.

As taught in my '549 patent, as the saturated melt cools and solidifies, the solubility of the dissolved gas displays a sharp decrease. The quantity of gas which represents the difference between the gas content dissolved in the melt and the amount which is soluble in the solidified material evolves in the form of gas bubbles immediately ahead of the solidification front. The gas bubbles grow concurrently with the solid and do not leave the solidification front thus forming a cellular structure.

The solidification pressure is controlled after pouring depending on the desired pore size, pore structure and void content. If a porous article exhibiting cylindrical pores is desired, the solidification pressure is held constant until solidification has been completed and the heat flow through the article is controlled. If a more intricate pore structure is desired (e.g. tapered, ellipsoidal or spherical pores) the solidification pressure is accordingly increased or decreased during solidification. If a nonporous region is desired in the resulting product, the solidification pressure is significantly increased above an upper pressure limit after which pore formation will not occur.

See also U.S. Pat. No. 6,250,362 in which there is disclosed a method and apparatus for producing porous metal which a gas is introduced into molten metal and the molten metal containing gas is spray coated onto a surface. According to the '362 patent, the amount and size of porosity contained in the porous metal is controlled by adjusting the conditions under which the gas is introduced into the molten metal, and also by controlling the conditions of the spray casting. According to the '362 patent, porous metal product having either isolated or interconnected porous structures may be produced. The spray casting apparatus described in the '362 patent includes a container for holding the molten metal, and means for introducing a gas into the molten metal. The container includes a molten metal discharge for discharging the molten metal containing gas onto a substrate.

The method and apparatus described in the '362 patent has several disadvantages. For one, it is difficult to maintain the molten metal in a pressurized vessel, saturated with gas, and then discharge the molten metal containing gas under controlled conditions particularly in the case of metals which have a melting temperature at or above about 1000° C. Additionally, the preferred gas (hydrogen) cannot be used with hydride forming metals such as titanium and zirconium. Moreover, the apparatus is bulky requiring a pressurized furnace with a special heating system inside the furnace, high-pressure gas valves and a need for a vacuum system to evacuate air before the metal is heated up.

### SUMMARY OF THE INVENTION

The present invention provides a method and apparatus for producing porous metals including high melting point metals as well as porous ceramics and alloys, which overcomes the aforesaid and other disadvantages of the prior art as discussed above. More particularly, in accordance with the present invention, there is provided a method and apparatus for forming porous metals, alloys and ceramic structures in which a plasma containing stream of liquid or solid/liquid particles of a feed material is directed onto a substrate under conditions such that the particles spot weld to the substrate or themselves without full fusion, and establishing relative movement between the plasma stream and the substrate whereby the material is deposited as a porous structure on the substrate. In a preferred embodiment of the invention, relative movement between the plasma torch and the substrate are controlled so as to form shaped articles.

### BRIEF DESCRIPTION OF THE DRAWINGS

Further features and advantages of the present invention will be seen from the following detailed description, taken in conjunction with the accompanying drawings, wherein like numerals depict like parts, and wherein:

FIG. 1 is a schematic view of an overall apparatus for manufacturing porous materials in accordance with the present invention;

FIGS. 2(a) and 2(b) are schematic sectional views illustrating a continuous process for producing a porous metal product in accordance with a first embodiment of the invention;

FIGS. 3(a) and 3(b) are views similar to FIGS. 2(a) and 2(b) showing a second embodiment of the invention;

FIGS. 4(a) and 4(b) are similar to FIGS. 2(a) and 2(b) showing yet another embodiment of the invention;

FIG. 5 is similar to FIG. 2(a) and illustrates still yet another embodiment of the invention;

FIG. 6 is a view similar to FIG. 5 illustrating yet another embodiment of the invention;

FIG. 7 is a view similar to FIG. 5 illustrating still yet another embodiment of the invention;

FIG. 8 is a view similar to FIG. 5 illustrating still yet another embodiment of the invention;

FIGS. 9(a) and 9(b) are cross-sectional views of porous metal products made in accordance with the present invention;

FIGS. 10, 11, 12(a)-12(g), 13(a) and 13(b) are views similar to FIG. 9, illustrating various solid-porous structures made in accordance with the present invention;

FIGS. 14(a)-14(d) and 15(a)-15(b) are shaped solid porous structures made in accordance with the present invention; and,

FIG. 16 is a graph of mechanical properties of porous metal products made in accordance with the present invention.

### DETAILED DESCRIPTION

The present invention provides a method and apparatus for producing porous materials in which a plasma stream containing particles of a base material in liquid or solid/liquid form is deposited onto a substrate under controlled conditions in which the particles spot weld to the substrate or to one another without full fusion, and establishing relative movement between the plasma stream and the substrate whereby the material is deposited as a porous structure of desired porosity and shape.

More particularly, in accordance with the present invention, liquid or solid/liquid particles of a feed material such as a metal are formed in a high energy jet device, e.g., a plasma torch or a laser to produce a high temperature high-energy dense plasma stream. The high-energy high-density plasma stream is then directed onto a substrate under conditions in which the individual particles spot-weld to the substrate surface or to themselves without full fusion. By establishing relative movement between the plasma stream and the substrate, the particles will spot weld in a pre-determined structure and pre-determined porosity without fusing into a solid mass. The resulting material is a porous structure comprising individual particles fused to the substrate and to one another with pores therebetween.

Optionally, a gas such as hydrogen may be injected into the high energy high density plasma to increase porosity of the resulting structure.

In accordance with one embodiment of the invention, there is provided a process of forming a porous article or porous coatings comprising the steps of:

providing a base material in powder form having predetermined particle size;

feeding the base material particles to a high energy jet device such as a plasma torch, heating the base material particles to reach a surface temperature around the melting point, and directing the heated particles onto a target area on a heated substrate under conditions where the particles spot weld to the substrate surface and between themselves without full fusion;

controlling heating speed, plasma torch temperature, and heating time to cause said particles to spot-weld on the substrate with a predetermined structure and predetermined porosity;

cooling the deposited material to cause local liquid spot solidification and form a gas-solid rigid structure in layer form; and

after forming a first porous layer depositing additional layers of particles, while controlling thermal, feeding and scanning parameters to produce a desired article shape, microstructure, physico-mechanical properties and pore-solid ratio.

In another embodiment of the invention, there is provided process of forming a porous solid article or porous coatings comprising the steps of:

providing a base material in wire form having a predetermined diameter;

feeding the material to a high energy jet device such as a plasma torch and heating the material to cause said material to melt and form molten drops, directing the molten drops onto a target area on a substrate, and depositing the drops on the substrate under conditions where the drops spot weld to the substrate surface and between themselves without full fusion;

controlling heating speed, plasma torch temperature, and heating time to cause said particles and the substrate to produce a structure of predetermined porosity;

cooling the deposited material to cause local liquid drops to solidify and form a gas/solid rigid structure in layer form;

after forming a first porous layer depositing additional layers to form layer-by-layer a three dimensional shaped article; and

controlling thermal, feeding, and scanning parameters to produce a desired article shape, microstructure, physico-mechanical properties and pore/solid ratio.

The amount of porosity and macrostructure of the formed porous articles may be controlled by controlling energy density inside the high energy jet, flow rate of base material, temperature, base material temperature, deposited base material cooling rate, jet or substrate motion parameters (speed, acceleration, oscillation and motion trajectory), orientation of gravitational field, relative scanning direction and high energy jet direction, level of gravitational force, presence and parameters of vibration, base material particle size, base material wire diameter, and base material particle shape.

In yet another embodiment of the invention, there is provided a process of forming a porous solid article or porous coatings comprising the steps of:

feeding a base material in wire or powder form having predetermined size to a high energy scanning jet device such as a scanning plasma torch and heating the material to molten state; exposing the molten material to an active gas in the plasma torch and dissolving the gas in the molten material;

depositing the gas containing base material on a substrate to form a liquid pool; and

controlling heating speed, plasma torch temperature, and heating time to cause the liquid pool to reach predetermined active gas concentration and predetermined temperature;

cooling the local liquid pool causing said melt to solidify;

controlling gas pressure, cooling speed and cooling direction during said cooling step to cause the gas to precipitate within the solidifying base material thereby forming pores in the base material and thereby forming a gas/solid structure in layer form having predetermined porosity; and

after forming a first porous layer repeating scanning of the scanning jet while controlling oscillation parameters, linear motions parameters; powder or wire feeding parameters to form layer-by-layer a three dimensional shaped article.

The amount of porosity and macrostructure in the porous articles may be controlled by controlling various parameters including energy density inside the jet, flow rate of the base material, jet temperature, base material temperature, base material cooling rate, jet or substrate motion parameters (speed, acceleration, oscillation and motion trajectory), orientation of gravitational field relative to scanning direction and high energy jet direction, level of gravitational force, presence and amount of vibration, total gas pressure inside the jet, active gas partial pressure, active gas flow rate, liquid pool temperature, ratio of active gas flow-to-base material flow, and liquid pool cooling rate and direction.

In still yet another embodiment of the invention, there is provided a process of forming a porous solid article or porous coatings comprising the steps of:

feeding a base material in wire or particle form to a high energy oscillating jet device such as a plasma torch together with an active gas generating solid substance of a predetermined mass ratio and heating the base material and solid substance to cause the material to melt and to cause the substrate to generate the active gas, whereupon the melted base material absorbs the active gas; depositing the melted base material with absorbed gas on the substrate to cause the base material to form a local liquid pool;

controlling heating speed, plasma torch temperature and heating time to cause the liquid pool to reach predetermined active gas concentration and predetermined temperature;

cooling the local liquid pool causing the melt to solidify;

controlling total gas pressure, cooling speed and cooling direction during the cooling step to cause the gas to precipitate within the solidifying base material thereby forming pores in the base material and thereby form a gas/solid structure in layer form having predetermined porosity; and

after forming a first porous layer repeating to form layer-by-layer a three dimensional shaped article; while

controlling the oscillation parameters, linear motions parameters; powder or wire feeding parameters.

Porosity and macrostructure may be controlled by controlling energy density inside the jet flow rate of the base material, jet temperature, base material temperature, jet or substrate motion parameters, i.e. speed, acceleration, oscillation and motion trajectory, orientation of gravitational field relative to scanning direction and jet direction, level of gravitational force, presence and amount of vibration, gas pressure inside the liquid pool temperature, ratio of active gas mass-to-base material mass and liquid pool cooling rate and direction.

There also is provided a process of forming a porous solid article or porous coatings comprising the steps of:

depositing a layer of a base material in wire or particle form and a hydrogen gas generating material such as a metal hydride, e.g. of Ti, Cr, V, La, Li, Ta, Nb, Pd, U or Y, in particle form, on a substrate;

directing a high energy jet such as a plasma torch onto the substrate to heat the base material and the hydrogen generating material on the substrate to cause the base material to form a local liquid pool, and cause the hydrogen generating material to decompose to release hydrogen gas and form a liquid/gas foam, controlling heating speed, energy jet temperature, and heating time to cause the liquid pool to reach predetermined hydrogen content and predetermined temperature, cooling the local liquid pool causing said foam to solidify; and

controlling gas pressure, cooling speed and cooling direction during the cooling step to cause the foam to form a gas/solid structure in layer form having a predetermined porosity;

after forming a first porous layer forming additional layers of base material and hydrogen gas generating material and heating the additional layer as before to form layer-by-layer a three dimensional shaped article; while

controlling the oscillation parameters, linear motion parameters and; powder or wire feeding parameters.

Amount of porosity in the porous article may be controlled by controlling energy density inside the jet, flow rate of base material, flow rate of hydrogen generating material, jet temperature, jet or substrate motion parameters i.e., speed, acceleration, oscillation and motion trajectory, orientation of gravitational field, relative scanning direction and jet direction, level of gravitational force, presence and parameters of vibration, total gas pressure inside the jet, liquid pool temperature, ratio of the hydrogen generating material mass to the base material and liquid pool cooling rate and direction.

In yet another embodiment of the invention, there is provided a process of forming a porous coating comprising the steps of:

feeding a base material in form of solid to a high energy jet device such as a plasma torch and heating the material to molten state;

feeding an active gas, preferably hydrogen, to the high energy jet device where it is absorbed in the molten base material; controlling heating speed, jet temperature, and heating time to cause said molten material to achieve a predetermined active gas concentration and predetermined temperature;

scan depositing the molten material onto a target substrate, while controlling gas pressure, cooling speed and cooling direction to cause the gas to precipitate within solidifying base material and form pores in the base material and thereby form a gas/solid structure in layer form having predetermined porosity; and

controlling scanning to build up the material on the substrate.

Amounts of porosity in the porous articles may be controlled by controlling the energy density inside the jet, jet temperature, substrate temperature, jet or substrate motion parameters, i.e. speed, acceleration, oscillation and motion trajectory, orientation of gravitational field, relative scanning direction and high energy jet direction, level of gravitational force, presence and parameters of vibration, total gas pressure inside the jet, active gas partial pressure, active gas flow rate; liquid pool temperature, ratio of active gas flow-to-base material flow, and liquid pool cooling rate and direction.

In yet another embodiment of the invention, there is provided a process for forming a solid skin on porous articles comprising the steps of:

providing an initial porous solid base or solid substrate;

locally heating selected areas of the porous substrate using a high energy jet device such as a plasma torch, to raise the temperature of the porous substrate surface to a temperature higher than its melting point whereby to form a local liquid pool;

controlling heating speed, jet temperature, and heating time to cause the liquid pool to reach predetermined temperature and size; and

controlling scanning of the jet and cooling speed and cooling direction of the local liquid pool to form a solid skin on the porous substrate.

In another alternative embodiment of the invention, there is provided a process of forming a solid skin on a porous article comprising the steps of:

providing an initial porous solid base or porous substrate;

feeding a skin forming material in powder or wire form having predetermined size and having a same or different chemical composition as the porous solid base or substrate, to a high energy jet device such as a plasma torch:

heating the skin forming material in the jet to melting and directing the melted skin forming material onto the substrate to raise the surface temperature of the porous substrate to a temperature higher than its melting point and to form local liquid pool;

controlling heating speed, jet temperature, and heating time to cause the liquid pool to reach a predetermined temperature and size; and,

cooling the local liquid pool under controlled cooling speed and cooling direction, to form a solid skin on said porous substrate.

In the aforesaid processes, the active gas preferably is selected from the group consisting of argon, nitrogen, hydrogen, helium, air, oxygen, carbon monoxide, carbonic gas, water and water steam, a gaseous hydrocarbon/steam, ammonia/steam, methane, and combinations thereof.

Relative movement between the target substrate and the high energy jet device may be achieved by moving the substrate, or by moving the high energy jet device, or by moving both the substrate and the high energy jet device simultaneously. Relative movement may be uniform motion, linear motion, nonlinear motion, accelerated motion, rotation motion, oscillatory motion, vibration motion or a combination of two or more of the aforesaid motions.

Preferred as the high energy jet device is a plasma torch, although other high energy drives including laser devices, concentrated solar light and electric arc devices advantageously may be used to practice the present invention.

The porous article may contain interconnected porosity, isolated porosity, or a combination of isolated and interconnected porosity, and may be formed in various structures including but not limited to sold layers, strips, rods, tubes.

Preferably the base material is a metal such as W, Cu, Mo, Ni, Al, Fe, Mg, Zr, Co, Be, Cr, Ti, Ta, Mn, Ag, Au, Bi, Cd, Ce, Cs, Hg, In, Ir, La, Li, Nb, Pb, Pd, Pt, Re, Sb, Sc, Se, Si, Sn, Sr, U, V, Y and Zn or a metal alloy, a ceramic, or a metal-ceramic composition.

If desired, the substrate may be placed into a magnetic or electromagnet field for achieving a higher porosity or more uniform macro and micro-structure, or the substrate may be placed into ultrasonic field for achieving a higher porosity and more uniform solid structure.

Also, if desired, where gas is fed to the jet device, gas pressure inside the jet device may be pulsated to achieve a higher porosity and more uniform structure.

The invention also provides an apparatus for producing a porous metal, comprising a high energy, high-density jet;

a feed for feeding a base material in powder or wire form to the jet;

a substrate onto which the base material is deposited;

a controller for controlling movement of the jet and/or the substrate in three dimensions;

a controller for controlling heating of the jet and for controlling deposition of material on the substrate;

a controller for controlling cooling of the substrate;

optionally including a feed for active and/or inert gases to the jet;

also optionally including magnetic and electromagnetic fields around the jet;

optionally including an ultrasonic generator; and

a computer for controlling operating parameters.

### DETAILED DESCRIPTION OF PREFERRED EMBODIMENT

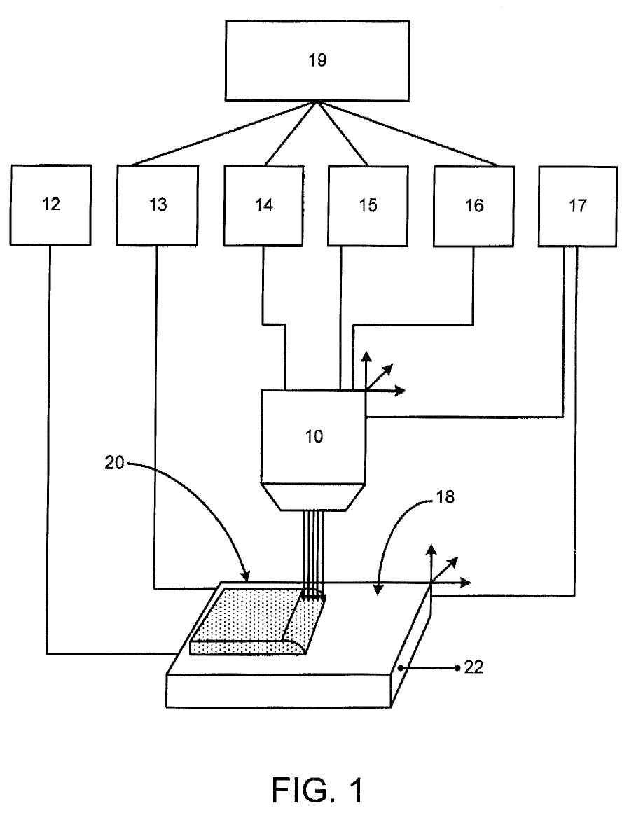

FIG. 1 illustrates a preferred embodiment of the present invention. The apparatus includes plasma transferred arc (PTA) plasma torch or laser light source 10 with a metal feed (not shown). The feed may comprise a metal wire feed or powder feed. The relative position of the plasma torch head is controlled by a multi-access motion controller (not shown) such as a multi-access CNC controller or a multi-access robotic controller. The motion of the torch head is controlled so as to deposit three-dimensional structures of metal on the surface 18 of a temperature controlled substrate 22 as will be described in detail below. The relative position of the target substrate 22 also may be controlled via a multi-access motion controller to further control deposition as will be described below.

A metal powder or wire supply are fed to the plasma transferred arc system 10 from a supply 16, to form a high energy high density plasma stream containing individual liquid or solid/liquid particles of metal. The resulting plasma stream is directed to the substrate 22 under controlled conditions such that the individual particles stick or weld to the substrate or to one another, in place, without flowing, or fusing into a solid mass. The temperature of substrate 22 is controlled by a cooling system 12. As a result, the particles spot weld to one another in layered form with spaces between each particle resulting in deposition of a porous material. The material may be built up layer-by-layer by depositing additional particles. Material porosity may be controlled by feed rate, particle size and cooling rate on the substrate surface. The shape of the deposit 20 optionally may also be controlled by a magnetic and electromagnet field controller 13.

More particularly, referring to FIG. 1, apparatus for manufacturing porous articles, porous-solid compositions, and porous coatings in accordance with the present invention includes:

10—high temperature plasma torch;

12/22—substrate and deposit cooling system;

13—magnetic and electromagnetic field controller;

14—gas supply system;

15—plasma (or laser) power supply;

16—powder and wire supply system;

17—3 D plasma torch (or laser) and substrate motion control system;

18—coolable substrate

19—computer and interface system.

Plasma torch 10 additionally includes a powder feed and/or wire feed system 16. The plasma torch is of a type which is generally known within the industry and is provided with the usual control systems. Powder feed and/or wire feed systems 16 can be programmed and controlling by computer 19. Base material and additions are supplied to the high temperature plasma zone under the torch 10. Feeding rate is programmed by the computer 19.

Substrate and deposit cooling system 22 controllably cools the plasma by cooling the plasma directly or cooling the substrate 18 under the plasma. Substrate 18 can be cooling by water or liquid nitrogen or argon. The plasma can be cooling by gaseous argon or liquid argon.

Magnetic and electromagnetic field controller 13 creates fields around the plasma and in this way influences the shape and orientation of metal particles and metal liquid local spots. If necessary porosity rate may be increased by compensating for gravity which tries to compress liquid and solid particles inside the plasma.

Gas supply system 14 may include an inert gas feeding around the plasma, i.e. a shield gas, plasma gas supply inside the plasma, and a active gas supply inside the plasma. Gas compositions and flow rate can be programmed.

Plasma (or laser) power supply 15 provides fully programmed and self-acting heating of the plasma.

Powder and wire supply system 16 provides powder and/or wire feed to the plasma. Feed rate can be programmed. Feed direction also can be changed manually.

Plasma torch (or laser) and substrate motion control system 17 can program 3 D motion of the torch and substrate. The motion control system controls rotation speeds and rotation direction of the substrate.

Coolable substrate 8 can be refractory material like graphite, tungsten, molybdenum, and ceramics and so on. And it can be forcedly cooling relatively easily melted metal like copper, aluminum and so on. Substrate shape determines start shape of the building porous article.

Computer and interface system 19 are controlling the above-mentioned systems.

Using the above described apparatus we can make porous articles, porous-solid compositions, and porous coatings with or without hydrogen or other active gases.

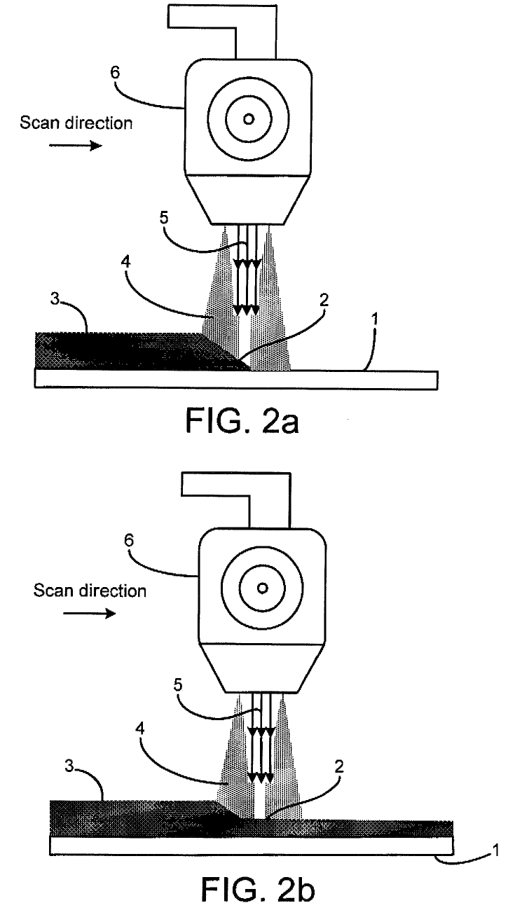

FIGS. 2(a) and 2(b) illustrate one embodiment of the invention and illustrate deposition of a first layer (FIG. 2a) following by a second layer (FIG. 2b) injecting a base material powder stream from a PTA, wherein

1—substrate

2—zone of forming welded 3-D structure

3—formed porous structure

4—base material powder stream

5—plasma (or laser) stream

6—plasma torch (or laser light)

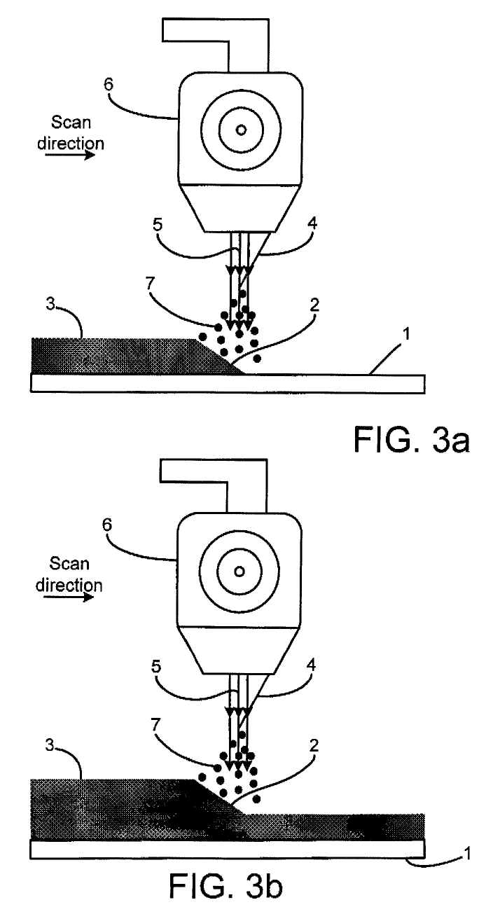

FIGS. 3(a) and 3(b) illustrate injection of a base material powder stream 7 directly into a plasma stream.

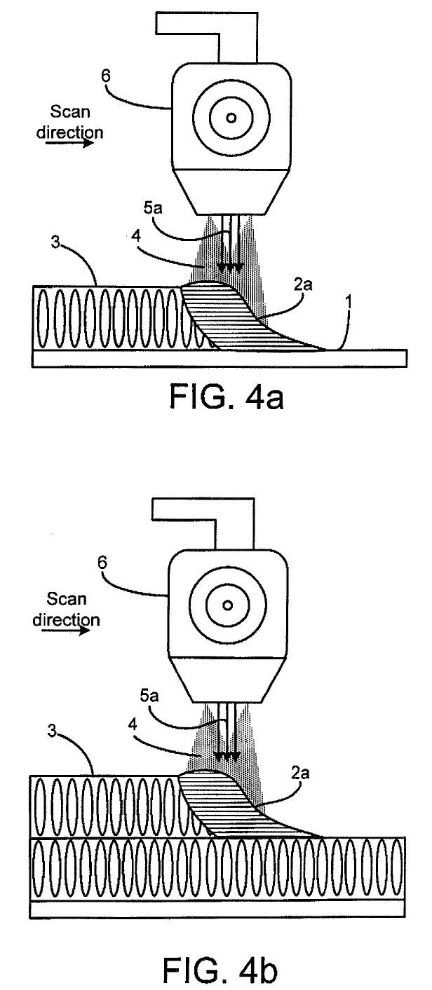

FIGS. 4(a) and 4(b) illustrate the formation of porous material in which a base hydrogen gas is introduced into the plasma stream 5a. This results in a liquid pool 2a saturated with hydrogen.

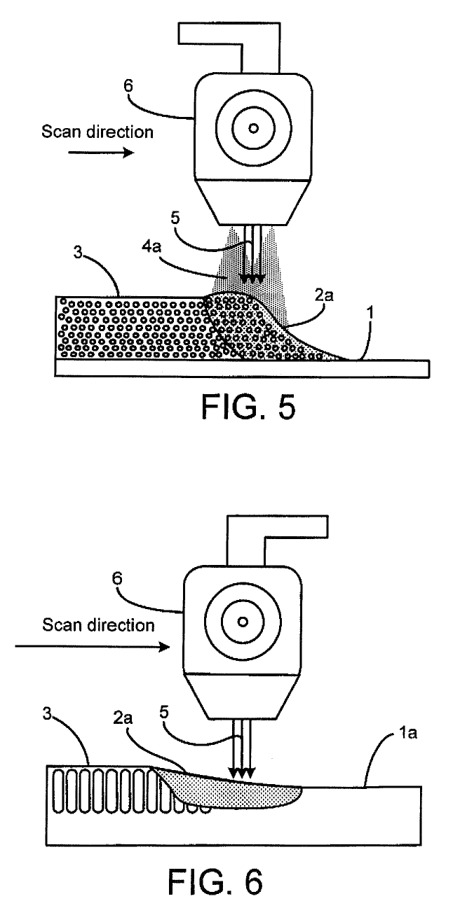

FIG. 5 illustrates an embodiment of the invention in which a base material and a hydrogen generating particle stream material 4 are ejected from a PTA and deposited on a substrate under controlled conditions. By controlling heating speed, PTA temperature and heating time of the base metal and hydrogen generating particle feed stream, and controlling cooling rate and cooling direction, a porous substrate may be built up in three dimensions.

Yet another alternative and embodiment is shown in FIG. 6. FIG. 6 starts with a substrate formed of a base material 1a saturated with hydrogen. A high energy plasma device is directed onto the substrate whereby to cause local rapid heat-up and form a local liquid pool 2a. The hydrogen gas is released and forms bubbles. By controlling heating time and temperature, it is possible to control gas concentration and distribution within the local liquid pool. The local liquid pool is then cooled to solidify the pool, whereby the gas precipitates within the solidifying base material forming pores in the base material.

Heating speed, heating temperature and heating time, cooling temperature, cooling speed and cooling direction all may be controlled to control the porosity of the finished product.

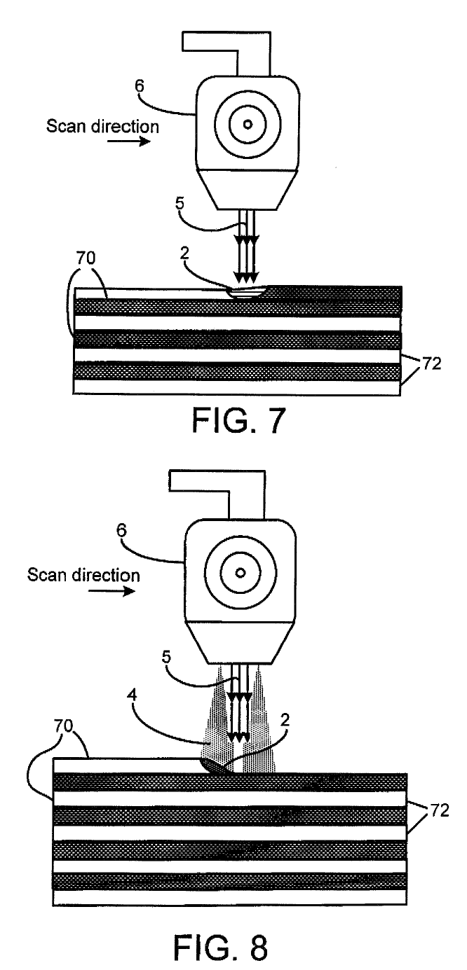

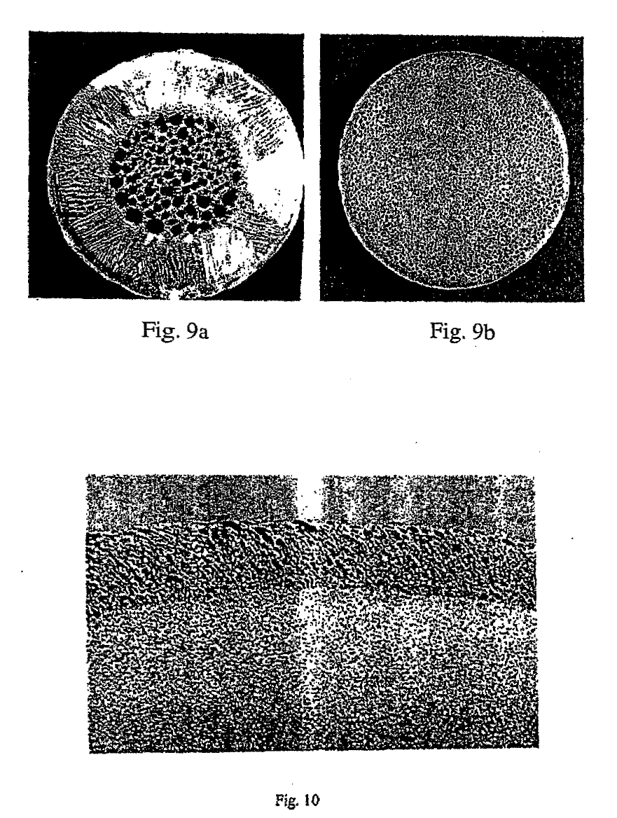

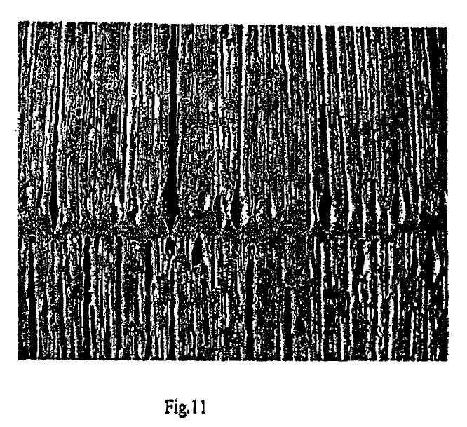

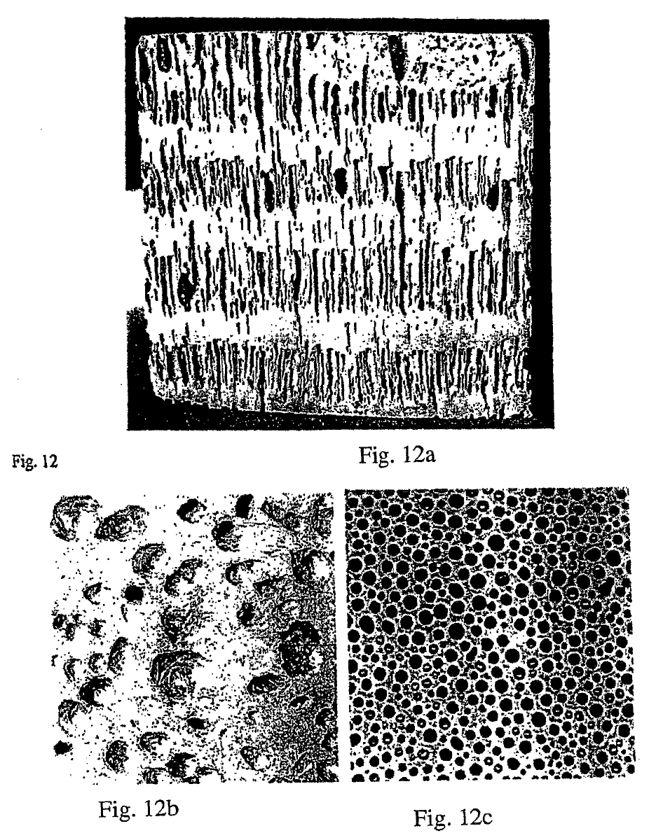

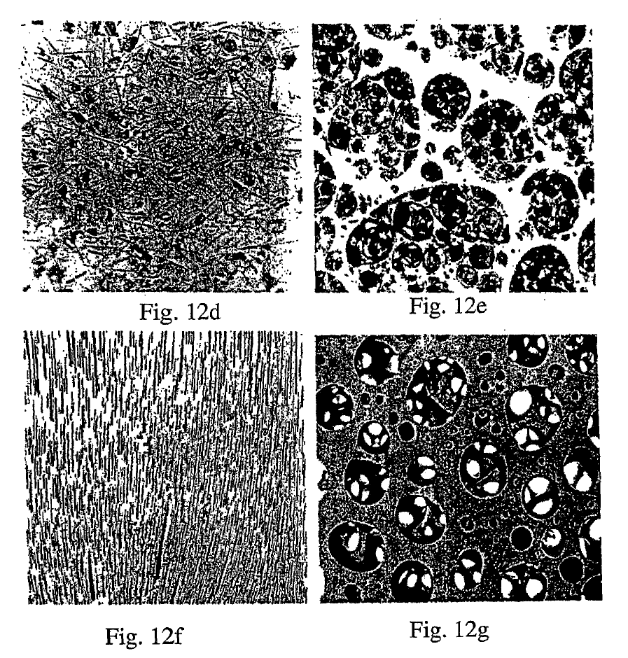

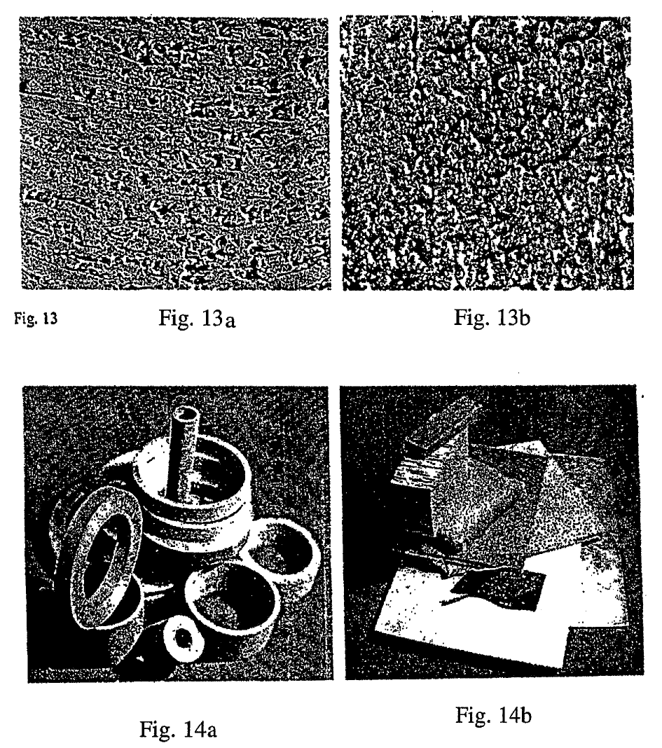

Yet other embodiments of the invention are illustrated in FIGS. 7 and 8 which illustrate the build up of a plurality of porous layers 70 separated by solid layers 72.

The invention will now be described in connection with the following non-limiting examples:

### EXAMPLES 1

### Titanium Foam Bar Produced From Powder

In this example we use Ti powder having particle size ranging from 10 to 2000 micron average size. Smaller particles give smaller pore size in the final product. In this particular example, particles 50-100 microns average size were used.

Pure argon was used as the shield gas and plasma gas.

A graphite plate or shaped graphite mandrel having the shape desired in the porous article is used as the substrate.

Programming: torch liner motion speed (7 inch (17.78 cm) per minute); torch oscillation parameters (amplitude—1 inch—(2.54 cm)—; period—2 seconds, and dwell in the extreme points 0.01 and 0.01 second); plasma power (current—70 Amps and voltage—30 V); torch motion trajectory—3 inches (7.62 cm) liner reciprocal; powder feed rate—1.7 (0.77 kg) pound per hour; number of layers—50.

Every layer can be programmed in individual parameters (if it is desired). So in this way layer by layer a porous rectangular body is formed that has a length 3 inch (7.62 cm), width 1 inch (2.54 c.m), and height—2 inches (5.08 cm). A porous product which exhibited—43%, average porosity and a pore size of 55 microns was produced.

### EXAMPLE 2

### Titanium Foam Tube Produced From Wire

In this example a wire 0.04″ (0.10 cm) diameter was used.

Pure argon was used as the shield gas and plasma gas.

A graphite disc was used as the substrate.

Programming: torch liner motion speed (10 inch (2.54 cm) per minute); torch oscillation parameters (amplitude—1 inch (2.54 cm), period—2 seconds, and dwell in the extreme points 0.01 and 0.01 second); plasma power (current—77 Amps and voltage—30 V); there was no torch motion trajectory; substrate rotation speed was 0.5 revs per minute; torch distance from center of rotation was 2 inches (5.04 cm); plane of substrate rotation was horizontal; powder feed rate was 2 pounds per hour (0.90 kg); number of revs—80. So in this way rev by rev the porous tubular body is formed with an inner diameter of 1.5 inch (3.81 cm), and an outer diameter of 2.5 inch (6.35 cm) with a porosity—47%, and average pore size of 65 microns.

### EXAMPLE 3

### Titanium Solid-Porous-Solid Bar Produced From Powder

In this case, particles 50-100 microns average size was used.

Pure argon was used as shield gas and plasma gas.

A graphite plate was used as the substrate.

Programming: torch liner motion speed (7 inch (17.78 cm)per minute); torch oscillation parameters (amplitude—1 inch (2.54 cm), period—2 seconds, and dwell in the extreme points 0.01 and 0.01 second); plasma power: first 10 layers—100 Amps; then next 30 layers 70 Amps, then next 15 layers 100 Amps; torch motion trajectory—3 inches (7.62 cm) liner reciprocal; powder feed rate—2.2 pounds (1 kg) per hour; number of layers—55.

A layered solid-porous-solid bar is formed that has a length 3 inches (7.62 cm), width 1 inch (2.54 cm), and height—1.7 inches (4.32 cm). The first layer is solid with a thickness of 0.2″ (0.51 cm), the porous layer thickness was 1.2″ (3.05 cm), and the second solid layer thickness was 0.3″ (0.76 cm). The porosity of the porous layer was—40%, and the average pore size was 55 microns in an architecture of a porous core with solid skins.

### EXAMPLE 4

### 304 Stainless Steel Foam Bar Produced From Powder

In this example particles of 70-250 microns average size were used.

Pure argon was used as the shield gas and plasma gas.

Hydrogen was used as the active gas.

As substrate we used a graphite plate for initial deposition which was then continued onto an alumina plate.

Programming: torch liner motion speed (9 inch (22.86 cm) per minute); torch oscillation parameters (amplitude—1 inch (2.54 cm), period—2 seconds, and dwell in the extreme points 0.01 and 0.01 second); plasma power (current—50 Amps and voltage—28 V); active gas (hydrogen) flow rate is 1.3 liter per minute; torch motion trajectory—3 inches (7.62 cm) liner reciprocal; powder feed rate—4.3 pound (1.95 kg) per hour; number of layers—50.

A porous rectangular body was formed that had a length of 3 inches (7.62 cm), width—1 inch (2.54 cm), and height—2.2 inches (5.59 cm). Porosity—45%, and pore size averaged 120 microns.

### EXAMPLE 5

### 304 Stainless Steel Foam Tube Produced From Wire

In this example stainless wire 0.04″ diameter was used.

Pure argon was used as the shield gas and plasma gas.

Hydrogen was used as the active gas.

A graphite disc was used as the substrate.

Programming: torch liner motion speed (10 inch per minute); torch oscillation parameters (amplitude—1 inch (2.54 cm), period—2 seconds, and dwell in the extreme points 0.01 and 0.01 second); plasma power (current—50 Amps and voltage—28 V); there is no torch motion trajectory; active gas (hydrogen) flow rate is 1.3 liter per minute; substrate rotation speed is 0.5 revs per minute; torch distance from center of rotation is 2 inches (5.08 cm); plane of substrate rotation is horizontal; powder feed rate is 3 pound (1.36 kg) per hour; number of revs—80.

A porous tubular body was formed in which the inner diameter was 1.5 inch, and outer diameter was 2.5 inch (6.35 cm). Porosity—50%, average with a pore size that averaged 230 microns.

### EXAMPLE 6

### 304 Stainless Steel Solid-Porous-Solid Bar Produced From Powder

In this example particles of 70-250 microns average size were used.

Pure argon was used as the shield gas and plasma gas.

Hydrogen was used as the active gas.

A graphite plate was used as the substrate.

Programming: torch liner motion speed (7 inch (17.78 cm) per minute); torch oscillation parameters (amplitude—1 inch (2.54 cm), period—2 seconds, and dwell in the extreme points 0.01 and 0.01 second); plasma power 50 Amps; active gas (hydrogen) flow rate is 0.0 liter per minute for the first 10 layers; then 1.3 liter per minute for the next 30 layers, then 0.0 liter per minute for the next 15 layers; torch motion trajectory—3 inches (7.62 cm) liner reciprocal; powder feed rate—4 pound (1.81 kg) per hour; number of layers—55.

A solid-porous-solid bar was formed that had a length of 3 inches (7.62 cm), width 1 inch (2.54 cm), and height—1.8 inches (4.57 cm). The first solid layer thickness was 0.2″ (0.51 cm); the porous layer thickness was 1.3″ (3.30 cm); and the second solid layer thickness was 0.3″ (0.76 cm). Porosity of the porous layer was—53%, and the average pore size was 250 microns.

### EXAMPLE 7

### 304 Stainless Steel Foam Bar Produced From Powder

In this example particles of 70-250 microns average size were used.

Pure argon was used as the shield gas and plasma gas.

Hydrogen was used as the active gas.

As substrate we use a graphite plate for the start and continued onto an alumina plate.

Programming: torch liner motion speed (9 inch (22.87 cm) per minute); torch oscillation parameters (amplitude—1 inch (2.54 cm), period—2 seconds, and dwell in the extreme points 0.01 and 0.01 second); plasma power (current—50 Amps and voltage—28 V); active gas (hydrogen) flow rate is 1.3 liter per minute; torch motion trajectory—3 inches (7.62 cm) liner reciprocal; electromagnetic field is 0.5 T; powder feed rate—2 pound (9.07 kg) per hour; number of layers—50.

A porous rectangular body was formed that had a length of 3 inches (7.62 cm), width—1 inch (2.54 cm), and height—2.2 inches (5.59 cm). Porosity—65%, average with a pore size averaging 320 microns.

Mechanical properties of the metal foams are much better than traditionally made porous metals (see Table 1)

TABLE I
Strength of Foam Metals

| Sample Produced in | | Strength of Foam |
|---|---|---|
| Example # | Porosity in % | Psi (kg/cm²) |
| 1 | 43 | 43,500 (3058) |
| 2 | 47 | 96,196 (6763) |
| 3 | 40 | 96,632 (6794) |

The present invention is simple in operation and ensures high productivity with the capability to produce large components while maintaining pore quality. This is in contrast to other processing which requires using an autoclave of large size that can maintain several atmospheres pressure as well as high temperatures to melt metals such as titanium at 1670° C. The present invention is thus much more economical.

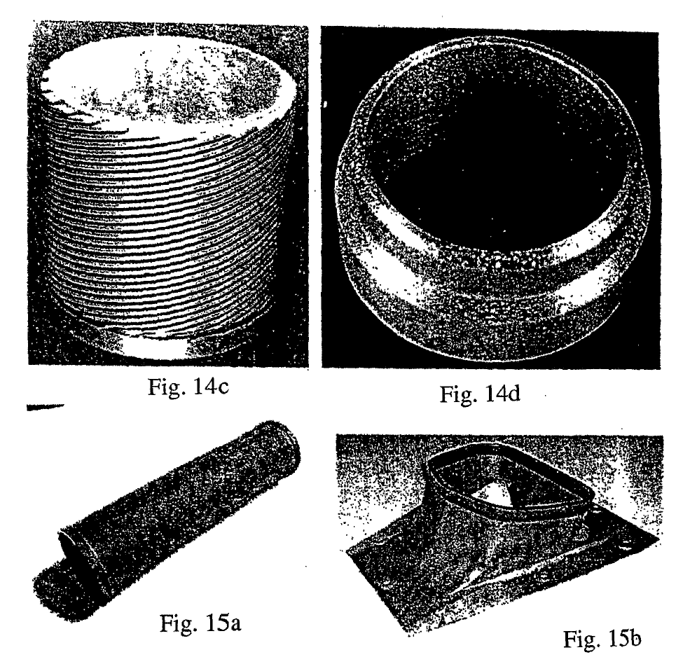

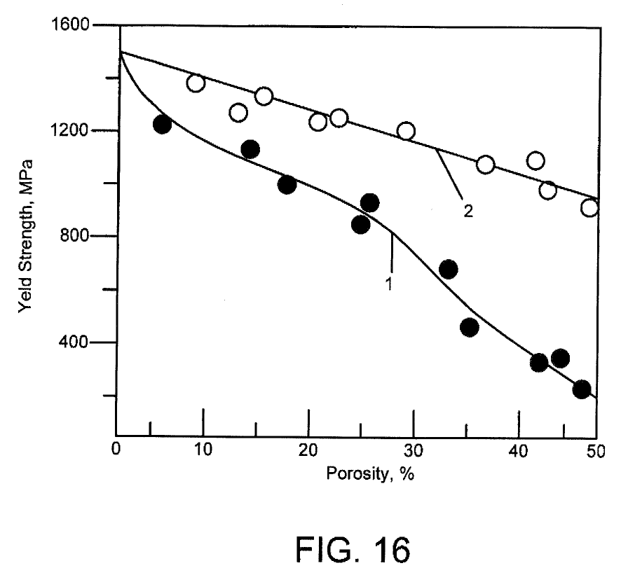

It has been observed that porous structures made in accordance with this invention exhibit superior mechanical properties, making them particularly useful, e.g. as combustion chambers for liquid rocket engines, exhaust systems, nozzles, filters, etc., some of which are illustrated in FIGS. 14a-14d, 15a and 15b. In particular, porous articles having pores of equal to or less than 100 microns in size with a porosity of equal to or less than 35% have a specific strength that is greater than that of the base material.

Various changes may be made in the invention without departing from the spirit and scope. For example, while a PTA plasma transferred arc system is described as being used to form the melt, a high energy source such as a laser advantageously may be used in place of a PTA.

Yet other features and advantages of the invention will be apparent to one skilled in the art.

1. A method for producing porous materials which comprises directing a plasma stream containing particles of a base material in liquid or solid/liquid form onto a substrate under controlled conditions in which the particles spot weld to the substrate or to one another without full fusion, and establishing relative movement between the plasma stream and the substrate whereby the material is deposited as a porous structure of desired porosity and shape.

2. The method of claim 1, wherein the base material comprises a metal and the plasma stream is formed in a plasma torch or a laser.

3. The method of claim 1, wherein relative movement between the plasma stream and the substrate is controlled to yield a porous structure having a pre-determined structure and pre-determined porosity.

4. The method of claim 1, including the step of injecting a gas into the plasma to increase porosity of the resulting structure.

5. The method of claim 4, wherein the gas comprises hydrogen.

6. A method for forming a porous article or porous coatings comprising the steps of:
providing a base material in powder form having predetermined particle size;
feeding the base material particles to a high energy jet device such as a plasma torch, heating the base material particles to reach a surface temperature around the melting point, and directing the heated particles onto a target area on a heated substrate under conditions where the particles spot weld to the substrate surface and between themselves without full fusion;
controlling heating speed, plasma torch temperature, and heating time to cause said particles to spot-weld on the substrate with a predetermined structure and predetermined porosity;
cooling the deposited material to cause local liquid spot solidification and form a gas-solid rigid structure in layer form; and
after forming a first porous layer depositing additional layers of particles, while controlling thermal, feeding and scanning parameters to produce a desired article shape, microstructure, physico-mechanical properties and pore-solid ratio.

7. A method for forming a porous solid article or porous coatings comprising the steps of:
providing a base material in wire form having a predetermined diameter;
feeding the material to a high energy jet device such as a plasma torch and heating the material to cause said material to melt and form molten drops, directing the molten drops onto a target area on a substrate, and depositing the drops on the substrate under conditions where the drops spot weld to the substrate surface and between themselves without full fusion;
controlling heating speed, plasma torch temperature, and heating time to cause said particles and the substrate to produce a structure of predetermined porosity;
cooling the deposited material to cause local liquid drops to solidify and form a gas/solid rigid structure in layer form;
after forming a first porous layer depositing additional layers to form layer-by-layer a three dimensional shaped article; and
controlling thermal, feeding, and scanning parameters to produce a desired article shape, microstructure, physico-mechanical properties and pore/solid ratio.

8. A method for forming a porous solid article or porous coatings comprising the steps of:
feeding a base material in wire or powder form having predetermined size to a high energy scanning jet device such as a scanning plasma torch and heating the material to molten state; exposing the molten material to an active gas in the plasma torch and dissolving the gas in the molten material;
depositing the gas containing base material on a substrate to form a liquid pool;
controlling heating speed, plasma torch temperature, and heating time to cause the liquid pool to reach predetermined active gas concentration and predetermined temperature;
cooling the local liquid pool causing said melt to solidify;
controlling gas pressure, cooling speed and cooling direction during said cooling step to cause the gas to precipitate within the solidifying base material thereby forming pores in the base material and thereby forming a gas/solid structure in layer form having predetermined porosity; and
after forming a first porous layer repeating scanning of the scanning jet while controlling oscillation parameters, linear motions parameters; powder or wire feeding parameters to form layer-by-layer a three dimensional shaped article.

9. A method for forming a porous solid article or porous coatings comprising the steps of:
feeding a base material in wire or particle form to a high energy oscillating jet device such as a plasma torch together with an active gas generating solid substance of a predetermined mass ratio and heating the base material and solid substance to cause the material to melt and to cause the substrate to generate the active gas, whereupon the melted base material absorbs the active gas;
depositing the melted base material with absorbed gas on the substrate to cause the base material to form a local liquid pool;
controlling heating speed, plasma torch temperature and heating time to cause the liquid pool to reach predetermined active gas concentration and predetermined temperature;
cooling the local liquid pool causing the melt to solidify;
controlling total gas pressure, cooling speed and cooling direction during the cooling step to cause the gas to precipitate within the solidifying base material thereby forming pores in the base material and thereby form a gas/solid structure in layer form having predetermined porosity; and
after forming a first porous layer repeating to form layer-by-layer a three dimensional shaped article; while controlling the oscillation parameters, linear motions parameters and/or powder or wire feeding parameters.

10. A method for forming a porous solid article or porous coatings comprising the steps of:
depositing a layer of a base material in wire or particle form and a hydrogen gas generating material such as a metal hydride, e.g. of Ti, Cr, V, La, Li, Ta, Nb, Pd, U or Y, in particle form, on a substrate;
directing a high energy jet such as a plasma torch onto the substrate to heat the base material and the hydrogen generating material on the substrate to cause the base material to form a local liquid pool, and cause the hydrogen generating material to decompose to release hydrogen gas and form a liquid/gas foam, controlling heating speed, energy jet temperature, and heating time to cause the liquid pool to reach predetermined hydrogen content and predetermined temperature, cooling the local liquid pool causing said foam to solidify;
controlling gas pressure, cooling speed and cooling direction during the cause the foam to form a gas/solid structure in layer form having a predetermined porosity;
after forming a first porous layer forming additional layers of base material and hydrogen gas generating material and heating the additional layer as before to form layer-by-layer a three dimensional shaped article, while controlling the oscillation parameters, linear motion parameters and/or powder or wire feeding parameters.

11. A method for forming a porous coating comprising the steps of:
feeding a base material in form of solid to a high energy jet device such as a plasma torch and heating the material to molten state;
feeding an active gas, preferably hydrogen, to the high energy jet device where it is absorbed in the molten base material;
controlling heating speed, jet temperature, and heating time to cause said molten material to achieve a predetermined active gas concentration and predetermined temperature;
scan depositing the molten material onto a target substrate, while controlling gas pressure, cooling speed and cooling direction to cause the gas to precipitate within solidifying base material and form pores in the base material and thereby form a gas/solid structure in layer form having predetermined porosity; and
controlling scanning to build up the material on the substrate.

12. A method for forming a solid skin on porous articles comprising the steps of:
providing an initial porous solid base or solid substrate;
locally heating selected areas of the porous substrate using a high energy jet device such as a plasma torch, to raise the temperature of the porous substrate surface to a temperature higher than its melting point whereby to form a local liquid pool;
controlling heating speed, jet temperature, and heating time to cause the liquid pool to reach predetermined temperature and size; and
controlling scanning of the jet and cooling speed and cooling direction of the local liquid pool to form a solid skin on the porous substrate.

13. A method for forming a solid skin on a porous article comprising the steps of:
providing an initial porous solid base or porous substrate;
feeding a skin forming material in powder or wire form having predetermined size and having a same or different chemical composition as the porous solid base or substrate, to a high energy jet device such as a plasma torch:
heating the skin forming material in the jet to melting and directing the melted skin forming material onto the substrate to raise the surface temperature of the porous substrate to a temperature higher than its melting point and to form local liquid pool;
controlling heating speed, jet temperature, and heating time to cause the liquid pool to reach a predetermined temperature and size; and, cooling the local liquid pool under controlled cooling speed and cooling direction, to form a solid skin on said porous substrate.

14. The method of claim 6, wherein amount of porosity in the porous article is controlled by controlling one or more operating parameters selected from the group consisting of controlling energy density inside the jet, controlling jet temperature, controlling substrate temperature, controlling jet or substrate motion parameters, controlling speed, acceleration, oscillation and motion trajectory of the jet or substrate, controlling orientation of gravity acting on the process, controlling relative scanning direction, controlling direction of movement of the high energy jet, controlling amount of gravitational force acting on the process, controlling vibration, and controlling total gas pressure inside the jet.

15. The method of claim 7, wherein amount of porosity in the porous article is controlled by controlling one or more operating parameters selected from the group consisting of controlling energy density inside the jet, controlling jet temperature, controlling substrate temperature, controlling jet or substrate motion parameters, controlling speed, acceleration, oscillation and motion trajectory of the jet or substrate, controlling orientation of gravity acting on the process, controlling relative scanning direction, controlling direction of movement of the high energy jet, controlling amount of gravitational force acting on the process, controlling vibration, and controlling total gas pressure inside the jet.

16. The method of claim 8, wherein amount of porosity in the porous article is controlled by controlling one or more operating parameters selected from the group consisting of controlling energy density inside the jet, controlling jet temperature, controlling substrate temperature, controlling jet or substrate motion parameters, controlling speed, acceleration, oscillation and motion trajectory of the jet or substrate, controlling orientation of gravity acting on the process, controlling relative scanning direction, controlling direction of movement of the high energy jet, controlling amount of gravitational force acting on the process, controlling vibration, and controlling total gas pressure inside the jet.

17. The method of claim 9, wherein the amount of amount of porosity in the porous article is controlled by controlling one or more operating parameters selected from the group consisting of controlling energy density inside the jet, controlling jet temperature, controlling substrate temperature, controlling jet or substrate motion parameters, controlling speed, acceleration, oscillation and motion trajectory of the jet or substrate, controlling orientation of gravity acting on the process, controlling relative scanning direction, controlling direction of movement of the high energy jet, controlling amount of gravitational force acting on the process, controlling vibration, and controlling total gas pressure inside the jet.

18. The method of claim 10, wherein the amount of amount of porosity in the porous article is controlled by controlling one or more operating parameters selected from the group consisting of controlling energy density inside the jet, controlling jet temperature, controlling substrate temperature, controlling jet or substrate motion parameters, controlling speed, acceleration, oscillation and motion trajectory of the jet or substrate, controlling orientation of gravity acting on the process, controlling relative scanning direction, controlling direction of movement of the high energy jet, controlling amount of gravitational force acting on the process, controlling vibration, and controlling total gas pressure inside the jet.

19. The method of claim 11, wherein the amount of amount of porosity in the porous article is controlled by controlling one or more operating parameters selected from the group consisting of controlling energy density inside the jet, controlling jet temperature, controlling substrate temperature, controlling jet or substrate motion parameters, controlling speed, acceleration, oscillation and motion trajectory of the jet or substrate, controlling orientation of gravity acting on the process, controlling relative scanning direction, controlling direction of movement of the high energy jet, controlling amount of gravitational force acting on the process, controlling vibration, and controlling total gas pressure inside the jet.

20. The method of claim 12, wherein the amount of amount of porosity in the porous article is controlled by controlling one or more operating parameters selected from the group consisting of controlling energy density inside the jet, controlling jet temperature, controlling substrate temperature, controlling jet or substrate motion parameters, controlling speed, acceleration, oscillation and motion trajectory of the jet or substrate, controlling orientation of gravity acting on the process, controlling relative scanning direction, controlling direction of movement of the high energy jet, controlling amount of gravitational force acting on the process, controlling vibration, and controlling total gas pressure inside the jet.

21. The method of claim 13, wherein the amount of amount of porosity in the porous article is controlled by controlling one or more operating parameters selected from the group consisting of controlling energy density inside the jet, controlling jet temperature, controlling substrate temperature, controlling jet or substrate motion parameters, controlling speed, acceleration, oscillation and motion trajectory of the jet or substrate, controlling orientation of gravity acting on the process, controlling relative scanning direction, controlling direction of movement of the high energy jet, controlling amount of gravitational force acting on the process, controlling vibration, and controlling total gas pressure inside the jet.

22. The method of claim 11, wherein the active gas is selected from the group of consisting of argon, nitrogen, hydrogen, helium, air, oxygen, carbon monoxide, carbonic gas, water and water steam, a gaseous hydrocarbon/steam, ammonia/steam, methane, and a combination thereof.

23. The method claim 1, wherein the base material is a metal selected from the group consisting of W, Cu, Mo, Ni, Al, Fe, Mg, Zr, Co, Be, Cr, Ti, Ta, Mn, Ag, Au, Bi, Cd, Ce, Cs, Hg, In, Ir, La, Li, Nb, Pb, Pd, Pt, Re, Sb, Sc, Se, Si, Sn, Sr, U, V, Y and Zn a metal alloy, a ceramic, and a metal-ceramic composition.

24. The method of claim 6, wherein the base material is a metal selected from the group consisting of W, Cu, Mo, Ni, Al, Fe, Mg, Zr, Co, Be, Cr, Ti, Ta, Mn, Ag, Au, Bi, Cd, Ce, Cs, Hg, In, Ir, La, Li, Nb, Pb, Pd, Pt, Re, Sb, Sc, Se, Si, Sn, Sr, U, V, Y and Zn a metal alloy, a ceramic, and a metal-ceramic composition.

25. The method of claim 7, wherein the base material is a metal selected from the group consisting of W, Cu, Mo, Ni, Al, Fe, Mg, Zr, Co, Be, Cr, Ti, Ta, Mn, Ag, Au, Bi, Cd, Ce, Cs, Hg, In, Ir, La, Li, Nb, Pb, Pd, Pt, Re, Sb, Sc, Se, Si, Sn, Sr, U, V, Y and Zn a metal alloy, a ceramic, and a metal-ceramic composition.

26. The method of claim 8, wherein the base material is a metal selected from the group consisting of W, Cu, Mo, Ni, Al, Fe, Mg, Zr, Co, Be, Cr, Ti, Ta, Mn, Ag, Au, Bi, Cd, Ce, Cs, Hg, In, Ir, La, Li, Nb, Pb, Pd, Pt, Re, Sb, Sc, Se, Si, Sn, Sr, U, V, Y and Zn a metal alloy, a ceramic, and a metal-ceramic composition.

27. The method of claim 9, wherein the base material is a metal selected from the group consisting of W, Cu, Mo, Ni, Al, Fe, Mg, Zr, Co, Be, Cr, Ti, Ta, Mn, Ag, Au, Bi, Cd, Cc, Cs, Hg, In, Ir, La, Li, Nb, Pb, Pd, Pt, Re, Sb, Sc, Se, Si, Sn, Sr, U, V, Y and Zn a metal alloy, a ceramic, and a metal-ceramic composition.

28. The method of claim 10, wherein the base material is a metal selected from the group consisting of W, Cu, Mo, Ni, Al, Fe, Mg, Zr, Co, Be, Cr, Ti, Ta, Mn, Ag, Au, Bi, Cd, Ce, Cs, Hg, In, Ir, La, Li, Nb, Pb, Pd, Pt, Re, Sb, Sc, Se, Si, Sn, Sr, U, V, Y and Zn a metal alloy, a ceramic, and a metal-ceramic composition.

29. The method of claim 11, wherein the base material is a metal selected from the group consisting of W, Cu, Mo, Ni, Al, Fe, Mg, Zr, Co, Be, Cr, Ti, Ta, Mn, Ag, Au, Bi, Cd, Ce, Cs, Hg, In, Ir, La, Li, Nb, Pb, Pd, Pt, Re, Sb, Sc, Se, Si, Sn, Sr, U, V, Y and Zn a metal alloy, a ceramic, and a metal-ceramic composition.

30. The method of claim 12, wherein the base material is a metal selected from the group consisting of W, Cu, Mo, Ni, Al, Fe, Mg, Zr, Co, Be, Cr, Ti, Ta, Mn, Ag, Au, Bi, Cd, Ce, Cs, Hg, In, Ir, La, Li, Nb, Pb, Pd, Pt, Re, Sb, Sc, Se, Si, Sn, Sr, U, V, Y and Zn a metal alloy, a ceramic, and a metal-ceramic composition.

31. The method of claim 13, wherein the base material is a metal selected from the group consisting of W, Cu, Mo, Ni, Al, Fe, Mg, Zr, Co, Be, Cr, Ti, Ta, Mn, Ag, Au, Bi, Cd, Ce, Cs, Hg, In, Ir, La, Li, Nb, Pb, Pd, Pt, Re, Sb, Sc, Se, Si, Sn, Sr, U, V, Y and Zn a metal alloy, a ceramic, and a metal-ceramic composition.

32. The method of claim 1, including the step of subjecting the substrate to a magnetic or electromagnet field to increase porosity or produce a more uniform macro and micro-structure.

33. The method of claim 6, including the step of subjecting the substrate to a magnetic or electromagnet field to increase porosity or produce a more uniform micro and micro-structure.

34. The method of claim 7, including the step of subjecting the substrate to a magnetic or electromagnet field to increase porosity or produce a more uniform macro and micro-structure.

35. The method of claim 8, including the step of subjecting the substrate to a magnetic or electromagnet field to increase porosity or produce a more uniform macro and micro-structure.

36. The method of claim 9, including the step of subjecting the substrate to a magnetic or electromagnet field to increase porosity or produce a more uniform macro and micro-structure.

37. The method of claim 10, including the step of subjecting the substrate to a magnetic or electromagnet field to increase porosity or produce a more uniform macro and micro-structure.

38. The method of claim 11, including the step of subjecting the substrate to a magnetic or electromagnet field to increase porosity or produce a more uniform macro and micro-structure.

39. The method of claim 12, including the step of subjecting the substrate to a magnetic or electromagnet field to increase porosity or produce a more uniform macro and micro-structure.

40. The method of claim 13, including the step of subjecting the substrate to a magnetic or electromagnet field to increase porosity or produce a more uniform macro and micro-structure.

41. The method of claim 1, including the step of subjecting the substrate to an ultrasonic field to produce a higher porosity and more uniform solid structure.

42. The method of claim 6, including the step of subjecting the substrate to an ultrasonic field to produce a higher porosity and more uniform solid structure.

43. The method of claim 7, including the step of subjecting the substrate to an ultrasonic field to produce a higher porosity and more uniform solid structure.

44. The method of claim 8, including the step of subjecting the substrate to an ultrasonic field to produce a higher porosity and more uniform solid structure.

45. The method of claim 9, including the step of subjecting the substrate to an ultrasonic field to produce a higher porosity and more uniform solid structure.

46. The method of claim 10, including the step of subjecting the substrate to an ultrasonic field to produce a higher porosity and more uniform solid structure.

47. The method of claim 11, including the step of subjecting the substrate to an ultrasonic field to produce a higher porosity and more uniform solid structure.

48. The method of claim 12, including the step of subjecting the substrate to an ultrasonic field to produce a higher porosity and more uniform solid structure.

49. The method of claim 13, including the step of subjecting the substrate to an ultrasonic field to produce a higher porosity and more uniform solid structure.

50. The method of claim 1, including the step of feeding a gas to the jet device in a pulsating manner.

51. The method of claim 6, including the step of feeding a gas to the jet device in a pulsating manner.

52. The method of claim 7, including the step of feeding a gas to the jet device in a pulsating manner.

53. The method of claim 8, including the step of feeding a gas to the jet device in a pulsating manner.

54. The method of claim 9, including the step of feeding a gas to the jet device in a pulsating manner.

55. The method of claim 10, including the step of feeding a gas to the jet device in a pulsating manner.

56. The method of claim 11, including the step of feeding a gas to the jet device in a pulsating manner.

57. The method of claim 12, including the step of feeding a gas to the jet device in a pulsating manner.

58. The method of claim 13, including the step of feeding a gas to the jet device in a pulsating manner.

59. An apparatus for producing a porous metal, comprising
a high energy, high-density jet;
a feed for feeding a base material in powder or wire form to the jet;
a substrate onto which the base material is deposited;
a controller for controlling movement of the jet and/or the substrate in three dimensions;
a controller for controlling heating of the jet and for controlling deposition of material on the substrate; and
a controller for controlling cooling of substrate.

60. The apparatus of claim 59, further including a feed for active and/or inert gases to the jet.

61. The apparatus according to claim 59, further including magnetic and electromagnetic fields around the jet.

62. The apparatus according to claim 59, further including an ultrasonic generator.

63. The apparatus according to claim 59, further including a computer for controlling operating parameters.

64. The apparatus according to claim 59, wherein the jet comprises a plasma torch, a laser, a concentrated solar light or an electric arc device.
